(19) United States
(12) Patent Application Publication
(10) Pub. No.: US 2011/0067031 A1
(43) Pub. Date: Mar. 17, 2011

(54) Information Processing Apparatus and Control Method of the Same

(76) Inventor: Daisuke Hosokawa, Hamura-shi (JP)

(21) Appl. No.: 12/877,746

(22) Filed: Sep. 8, 2010

(30) Foreign Application Priority Data
Sep. 16, 2009 (JP) 2009-213985

(51) Int. Cl. G06F 9/46

(52) U.S. Cl. 718/102

(57) ABSTRACT

According to one embodiment, an information processing apparatus for executing at least one executing target program, the apparatus includes: a sensor module configured to detect whether an operator is absent or not; a log information acquiring module configured to acquire log information including information about a date and time on which whether the operator is absent or not is detected by the sensor module and information about whether the operator is absent or not; a scheduling module configured to analyze an absence time zone in which the operator is absent based on the log information acquired by the log information acquiring module and to set to execute the at least one executing target program in the absence time zone based on a result of the analysis; and a processor configured to execute the at least one executing target program in the absence time zone.

### CROSS-REFERENCE TO RELATED APPLICATION

This application is based on and claims priority under 35 U.S.C. §119 from Japanese Patent Application No. 2009-213985 filed on Sep. 16, 2009.

### BACKGROUND

1. Field

One embodiment of the present invention relates to an information processing apparatus and more particularly to a control of an information processing apparatus using a human detecting sensor.

2. Description of the Related Art

In recent years, there has been known an information processing apparatus such as a personal computer (PC) in which predetermined software (for example, virus countermeasure software) is automatically executed at a preset date and time.

As one of the information processing apparatuses of this type, there has been proposed an information processing apparatus for automatically executing a diagnosis of a diagnosing target device such as a main storage device or peripheral equipment at a time which is set depending on a usage frequency of each of the devices (see JP-A-7-225701).

According to the information processing apparatus, it is possible to automatically carryout a diagnosis equally without a manpower depending on a usage frequency.

In the information processing apparatus described in JP-A-7-225701, however, a self-diagnosing program of the diagnosing target device is started in a timing in which the diagnosing target device is unused, and the self-diagnosing program is executed when an operator is present so that a complicated situation for the operator might be caused.

### BRIEF DESCRIPTION OF THE DRAWINGS

A general architecture that implements the various features of the invention will now be described with reference to the drawings. The drawings and the associated descriptions are provided to illustrate embodiments of the invention and not limited the scope of the invention.

FIG. 1 is an exemplary perspective view showing an information processing apparatus according to an embodiment of the invention;

FIG. 2 is an exemplary block diagram showing a system structure of the information processing apparatus shown in FIG. 1;

FIG. 3 is an exemplary functional block diagram for explaining a functional structure of the information processing apparatus shown in FIG. 1;

FIG. 4 is an exemplary diagram for explaining an example of log information stored in a log information storing module shown in FIG. 3;

FIG. 5 is an exemplary diagram for explaining an example of program information stored in a program information storing module shown in FIG. 3;

FIG. 6 is an exemplary diagram for explaining an example of scheduling information stored in a scheduling information storing module shown in FIG. 3;

FIG. 7 is an exemplary flowchart showing an example of a processing of a control method according to the embodiment, illustrating an example of a processing procedure in an absence of an operator;

FIG. 8 is an exemplary flowchart showing an example of the processing of the control method according to the embodiment, illustrating an example of a processing procedure in a detection of a presence of the operator; and

FIG. 9 is an exemplary flowchart showing an example of the processing of the control method according to the embodiment, illustrating an example of a processing procedure for scheduling.

### DETAILED DESCRIPTION

Various embodiments according to the invention will be described hereinafter with reference to the accompanying drawings. In general, according to one embodiment of the invention, an information processing apparatus and a control method which can automatically execute a predetermined program when an operator is absent.

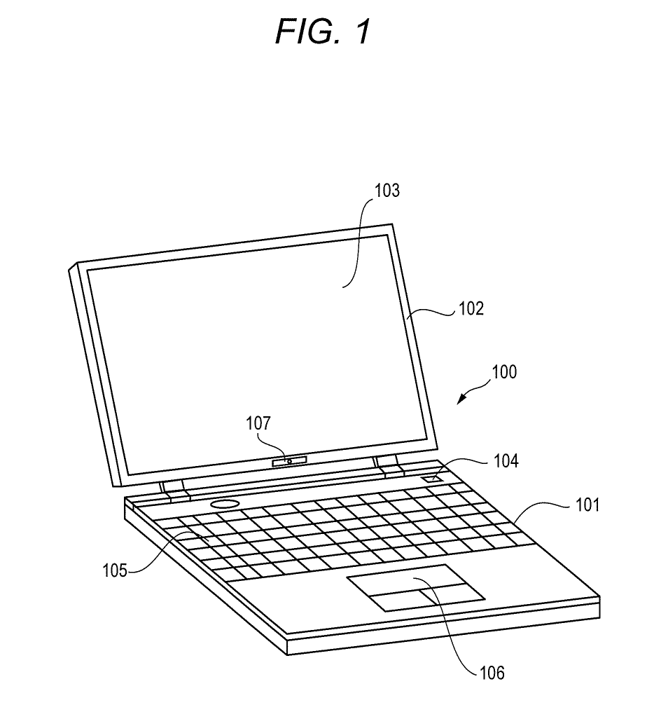

A structure of an information processing apparatus according to an embodiment of the invention will be described with reference to FIGS. 1 to 3. The information processing apparatus is implemented as a notebook type personal computer 100 (hereinafter referred to as a computer 100) which can be battery driven, for example.

FIG. 1 is a perspective view showing the computer 100 in a state in which a display unit is opened. The computer 100 is constituted by a body unit 101 and a display unit 102.

A display device constituted by an LCD (Liquid Crystal Display) 103 is embedded in the display unit 102. A display module of the LCD 103 is disposed on almost a center of the display unit 102. Moreover, an infrared sensor 107 as a human detecting sensor is provided in a lower part of the center of the display unit 102.

The display unit 102 is supported on the body unit 101 and is attached rotatably with respect to the body unit 101 between an opened position in which an upper surface of the body unit 101 is exposed and a closed position in which the upper surface of the body unit 101 is covered.

The body unit 101 has a housing taking a shape of a thin box, and a power button 104 for turning ON/OFF the computer 100, a keyboard 105 and a touch pad 106 are disposed on the upper surface of the body unit 101.

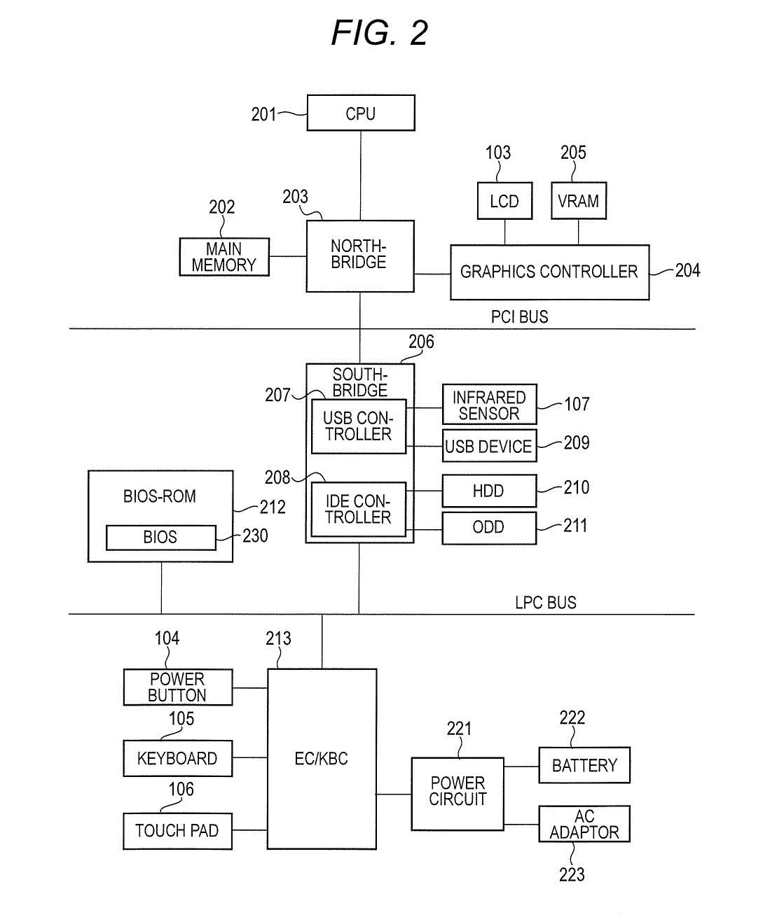

FIG. 2 is a block diagram showing a system structure of the computer 100.

As shown in FIG. 2, the computer 100 includes a CPU 201, a main memory 202, a northbridge 203, a graphics controller 204, the LCD 103, a VRAM 205, a southbridge 206, a USB controller 207, an IDE controller 208, the infrared sensor 107 to be a USB device, a USB device 209, a hard disk drive (HDD) 210, an optical disc drive (ODD) 211, a BIOS-ROM 212, the power button 104, the keyboard 105, the touch pad 106, an embedded controller/keyboard controller (EC/KBC) 213, a power circuit 221, a battery 222 and an AC adaptor 223.

The CPU 201 is a processor for controlling a whole operation of the computer 100. The CPU 201 executes OS and various application programs which are loaded into the main memory 202. The OS and various application programs are stored in a magnetic disk storage medium (a hard disk) provided in the HDD 210 and are loaded from the storage medium into the main memory 202.

Moreover, the CPU 201 also executes a BIOS program 230 stored in the BIOS-ROM 212 (which will be hereinafter referred to as BIOS). The BIOS-ROM 212 takes a configuration of a nonvolatile memory such as a flash EEPROM so as to be program rewritable.

The BIOS 230 is a program for controlling various hardware components of the computer 100 and is read from the BIOS-ROM 212 in a starting operation of the computer 100.

The northbridge 203 is a bridge device for connecting a local bus of the CPU 201 to the southbridge 206. The northbridge 203 includes a memory controller for access controlling the main memory 202. Moreover, the northbridge 203 has a function for communicating with the graphics controller 204 through an AGP (Accelerated Graphics Port) bus.

The graphics controller 204 serves to control the LCD 103 to be used as a display monitor of the computer 100. The graphics controller 204 outputs, to the LCD 103, a video signal corresponding to display data written to the VRAM 205 in accordance with the OS or application program.

The southbridge 206 controls each device over an LPC (Low Pin Count) bus and a PCI (Peripheral Component Interconnect) bus. Moreover, the southbridge 206 includes the USB controller 207 for controlling the infrared sensor 107 and the USB device 209 and the IDE controller 208 for controlling the HDD 210 and the ODD 211.

The HDD 210 is a storage device having a hard disk controller and a magnetic disk storage medium. The magnetic disk storage medium stores various software including the OS and various data. The ODD 211 is a drive unit for driving a storage medium, for example, a DVD storing video contents such as a DVD title or a CD storing music data.

The EC/KBC 213 is a one-chip microcomputer in which an embedded controller (EC) for a power management and a keyboard controller (KBC) for controlling the keyboard 105 and the touch pad 106 are integrated. The EC/KBC 213 is always turned ON by a power supplied from the power circuit 221 irrespective of ON/OFF operations of the computer 100. The EC/KBC 213 turns ON/OFF the computer 100 in cooperation with the power circuit 221 in response to an operation of the power button 104 by a user.

The power circuit 221 supplies a power to each device in the computer 100 by using a power fed from the battery 222 provided in the body unit 101 or a power fed from an external power supply through the AC adaptor 223 under control of the EC/KBC 213.

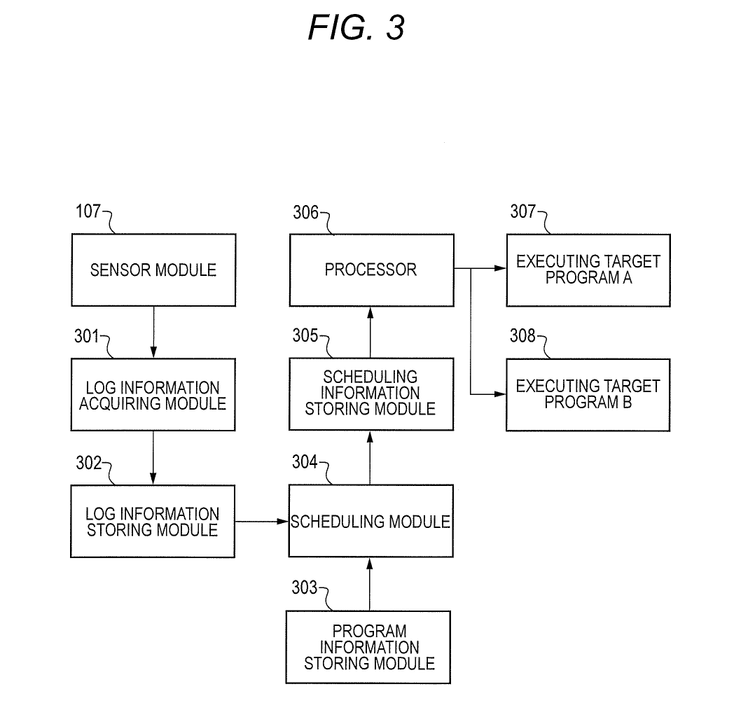

FIG. 3 is a functional block diagram for explaining a functional structure of the computer 100 according to the embodiment.

The sensor module (the infrared sensor) 107 periodically checks presence of an operator in a front space of the display unit 102 (every 30 seconds, for example) and detects whether the operator is present on a front of the computer 100 or not. When detecting the present/absent state of the operator, the sensor module 107 transmits a state detecting signal indicative of the present/absent state of the operator to log information acquiring module 301. In other words, the sensor module 107 transmits a state detecting signal indicating that the operator is present to the log information acquiring module 301 when detecting that the operator is present before the computer 100, and transmits a state detecting signal indicating that the operator is absent to the log information acquiring module 301 when detecting that the operator is not present before the computer 100.

Upon receipt of the state detecting signal indicative of the present/absent state of the operator from the sensor module 107, the log information acquiring module 301 outputs, to a log information storing module 302, date and time information (a time stamp) about the present/absent state of the operator and the receipt of the state detecting signal (that is, information about a date and time that the presence/absence of the operator is detected) in response to the state detecting signal.

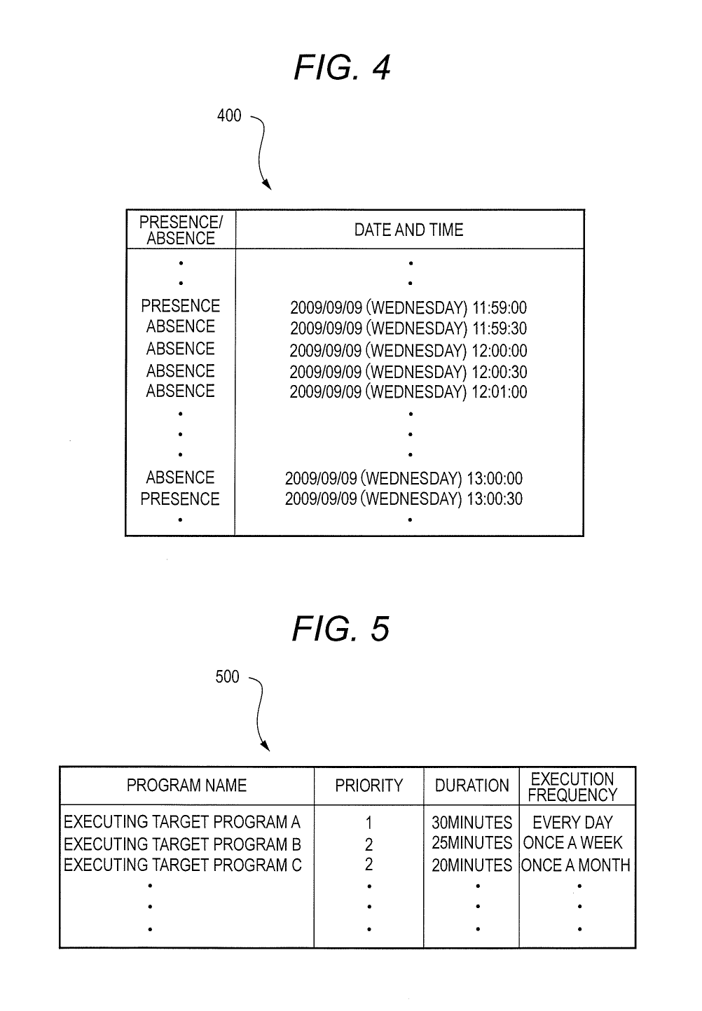

The log information storing module 302 stores information output from the sensor module 107. Hereinafter, the information stored in the log information storing module 302 will also be referred to as log information. FIG. 4 is a diagram for explaining an example of log information 400 stored in the log information storing module 302.

A program information storing module 303 stores a priority, a duration and an execution frequency (for example, every day, once a week or once a month) for an executing target program such as an executing target program A 307 or an executing target program B 308. The priority represents order for setting a schedule by a scheduling module 304 which will be described below. In the case in which the operator manually sets an execution time in relation to the order for carrying out the schedule setting over the executing target program, the executing target program is first set and the executing target program having the second highest priority is set. In the case in which there is a plurality of executing target programs having an equal priority, any of the executing target programs which takes a longer duration is set earlier. However, order for executing the executing target program is not restricted to the foregoing. Moreover, the information can also be changed by an operator through a set screen which is not shown. Hereinafter, the information stored in the program information storing module 303 will also be referred to as program information. FIG. 5 is a diagram for explaining an example of program information 500 stored in the program information storing module 303.

The scheduling module 304 analyzes a time zone having a high probability of the absence every day of week and time based on the log information stored in the log information storing module 302, for example, log information corresponding to a last week, and extracts the time zone as a result of the analysis. For example, the scheduling module 304 analyzes the log information stored in the log information storing module 302 and thus extracts a time zone in which the operator is absent, for example, the operator is absent from 12:00 to 13:00 every day or is absent from 15:00 to 16:00 on Thursday. Then, the scheduling module 304 outputs information about a date and time for the execution of the executing target program to a scheduling information storing module 305 based on the time zone extracted through the analysis of the log information and the program information stored in the program information storing module 303.

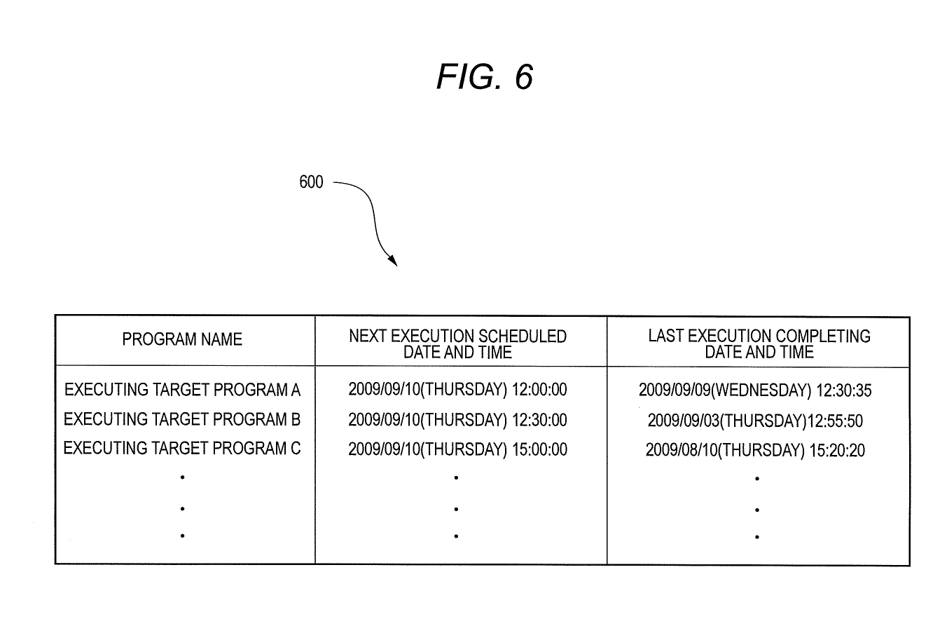

The scheduling information storing module 305 stores the information output from the scheduling module 304. More specifically, the scheduling information storing module 305 stores a scheduled date and time that a processor 306 is to execute the executing target program and a date and time that the executing target program was executed last time. The scheduled date and time that the executing target program is to be executed can be automatically set by the scheduling module 304, and furthermore, the operator can also manually set the date and time through the set screen which is not shown. Hereinafter, the information stored in the scheduling information storing module 305 will also be referred to as scheduling information. FIG. 6 is a diagram for explaining an example of scheduling information 600 stored in the scheduling information storing module 305.

The processor 306 executes the executing target program such as the executing target program A 307 or the executing target program B 308 based on the scheduling information stored in the scheduling information storing module 305. Moreover, the processor 306 interrupts or stops the executing target program when detecting the presence of the operator by the sensor module 107 while the executing target program is executed.

The executing target program A 307 and the executing target program B 308 include an HDD check program and a radiation check program, for example.

In the embodiment, the CPU 201 reads and executes a program stored in the HDD 210 and serving to implement the embodiment, thereby functioning as the log information acquiring module 301, the scheduling module 304 and the processor 306.

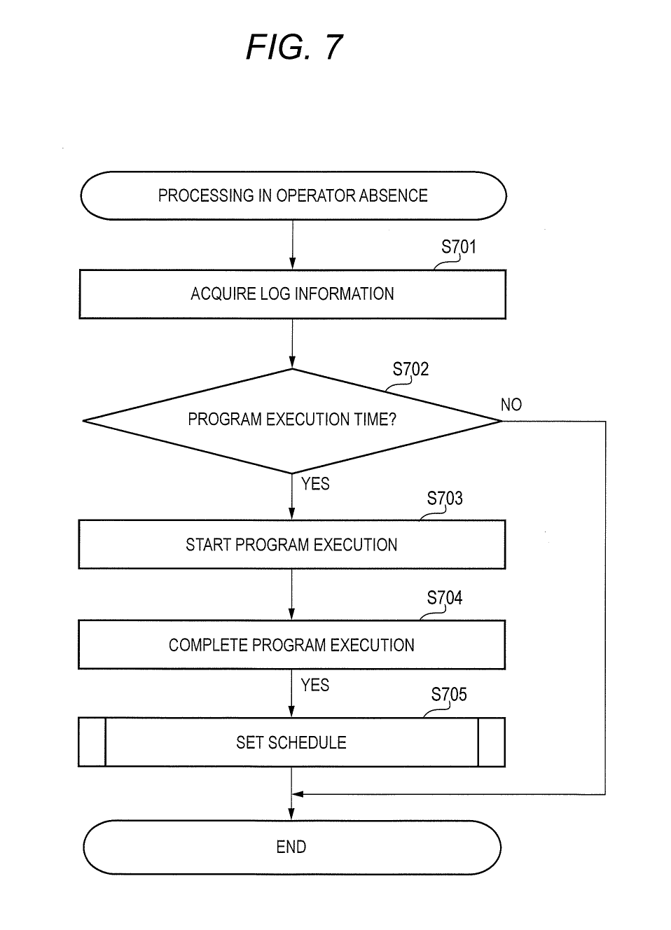

Next, a processing procedure for a control method in the computer 100 according to the embodiment will be described with reference to FIGS. 7 to 9.

FIG. 7 is a flowchart showing an example of a processing procedure for an absence of an operator in the computer 100 according to the embodiment.

When the sensor module 107 first detects the absence of the operator and transmits the state detecting signal to the log information acquiring module 301, the log information acquiring module 301 outputs, to the log information storing module 302, the absence of the operator and the date and time information (the time stamp) (Step S701).

Next, if the time that the executing target program set by the scheduling module 304 is to be executed is not reached (NO in Step S702), the processing is ended.

On the other hand, if the time that the executing target program set by the scheduling module 304 is to be executed is reached (YES in the Step S702), the processor 306 executes the executing target program in accordance with the scheduling information stored in the scheduling information storing module 305 (Step S703). The processor 306 continuously executes a plurality of executing target programs which is scheduled to be executed in the time zone if any.

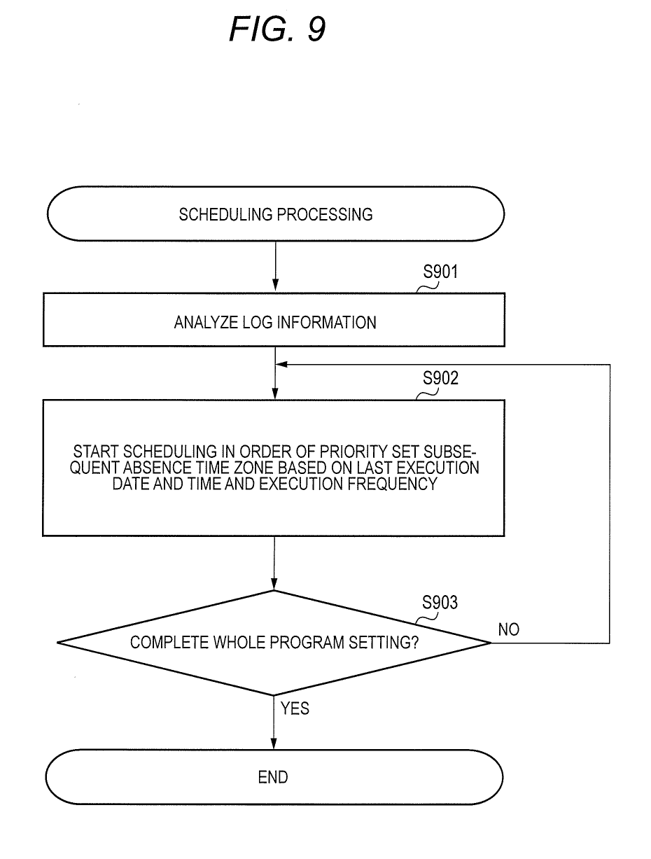

When the scheduled executing target program is then executed completely (Step S704), the scheduling module 304 carries out scheduling for the executing target program based on the result of the analysis for the log information stored in the log information storing module 302 (Step S705). The details of the scheduling processing will be described below with reference to FIG. 9.

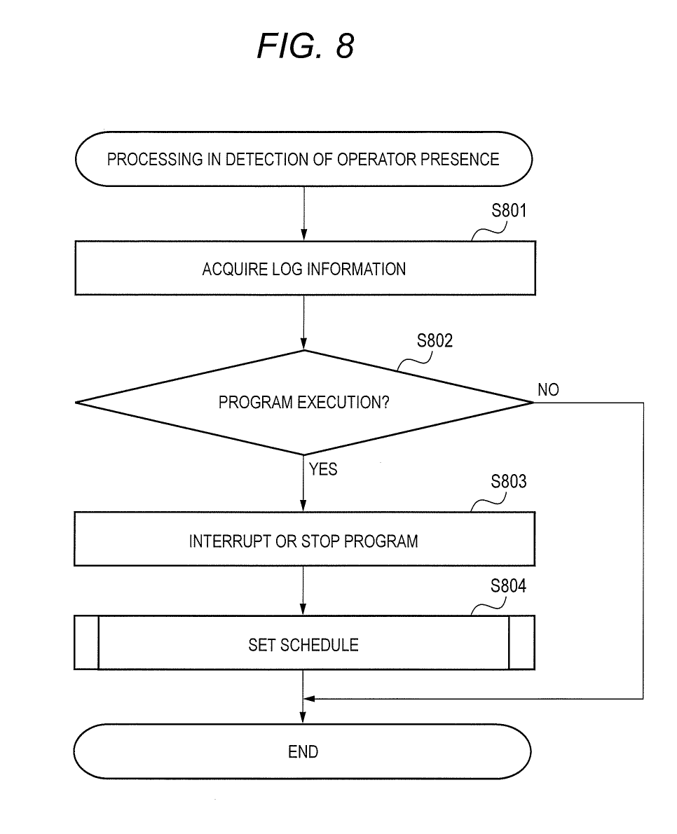

FIG. 8 is a flowchart showing an example of a processing procedure in the detection of the presence of the operator in the computer 100 according to the embodiment.

When the sensor module 107 first detects that the operator is present and transmits the state detecting signal to the log information acquiring module 301, the log information acquiring module 301 outputs, to the log information storing module 302, the presence of the operator and the date and time information (the time stamp) (Step S801).

Next, if the executing target program is not executed by the processor 306 (NO in Step S802), the processing is ended.

On the other hand, if the executing target program is being executed by the processor 306 (YES in the Step S802), the processor 306 interrupts or stops the executing target program which is being executed depending on a type of the executing target program (Step S803).

Next, the scheduling module 304 carries out scheduling over the executing target program based on the result of the analysis for the log information stored in the log information storing module 302 (Step S804). The details of the scheduling processing will be described below with reference to FIG. 9.

FIG. 9 is a flowchart showing an example of a processing procedure for the scheduling in the computer 100 according to the embodiment. The processing corresponds to the Step S705 shown in FIG. 7 and the Step S804 shown in FIG. 8.

First of all, the scheduling module 304 analyzes the log information stored in the log information storing module 302 and extracts, as a result of the analysis, the time zone in which the operator is absent (Step S901).

Next, the scheduling module 304 starts the scheduling for the executing target program in order of the priority stored in the program information storing module 303 (Step S902). At this time, the scheduling module 304 sets an executing date and time to the time zone for the absence of the operator which is the result of the analysis extracted at the Step S901 at an interval of the executing frequency stored in the program information storing module 303 from a last execution completing date and time every executing target program and outputs the information to the scheduling information storing module 305 (see FIG. 6). When the processor 306 interrupts the executing target program which is being executed at the Step S803 shown in FIG. 8, the scheduling module 304 can set to execute the executing target program on a point where the execution is interrupted.

If the whole schedule setting is not completed (NO at Step S903), the scheduling module 304 carries out the schedule setting for a next executing target program. If the whole schedule setting is completed (YES at the Step S903), the processing is ended.

Although the time zone for executing the executing target program is subjected to the scheduling depending on the information about the presence/absence of the operator in the embodiment, it is also possible to carry out a control so as not to execute the executing target program when a load of a system (a CPU usage rate) is high.

According to the embodiment, it is possible to effectively utilize an absence time for the operator, thereby executing a predetermined program in an operation of the information processing apparatus. If an HDD check program or a radiation check program is executed as the program, moreover, an inspection of an HDD is periodically executed without a special consciousness of the operator. Thus, it is possible to grasp, with high precision, a deterioration in a performance which is caused by aging.

Namely, there are provided an information processing apparatus and a control method which can automatically execute a predetermined program when an operator is absent.

Although the suitable embodiment according to the invention has been described above, the invention is not exactly restricted to the embodiment but the components can be changed and made concrete without departing from the scope thereof.

The invention is not limited to the foregoing embodiments but various changes and modifications of its components may be made without departing from the scope of the present invention. Also, the components disclosed in the embodiments may be assembled in any combination for embodying the present invention. For example, some of the components may be omitted from all the components disclosed in the embodiments. Further, components in different embodiments may be appropriately combined.

What is claimed is:

1. An information processing apparatus for executing at least one executing target program, the apparatus comprising:
a sensor module configured to detect whether an operator is absent or not;
a log information acquiring module configured to acquire log information including information about a date and time on which whether the operator is absent or not is detected by the sensor module and information about whether the operator is absent or not;
a scheduling module configured to analyze an absence time zone in which the operator is absent based on the log information acquired by the log information acquiring module and to set to execute the at least one executing target program in the absence time zone based on a result of the analysis; and
a processor configured to execute the at least one executing target program in the absence time zone.

2. The apparatus of claim 1, wherein
when the sensor module detects that the operator is present while the at least one executing target program is executed by the processor, the processor interrupts or stops the execution of the at least one executing target program.

3. The apparatus of claim 2, wherein
after the processor interrupts or stops execution of the at least one executing target program, the scheduling module analyzes a further absence time zone of the operator based on the log information acquired by the log information acquiring module to set to execute the at least one executing target program in the further absence time zone based on a result of the analysis.

4. The apparatus of claim 2, wherein
after the processor interrupts execution of the at least one executing target program, the scheduling module analyzes a further absence time zone of the operator based on the log information acquired by the log information acquiring module to set to execute the at least one executing target program in the further absence time zone on a point where the execution of the at least one executing target program is interrupted based on a result of the analysis.

5. A method of controlling an information processing apparatus for executing at least one executing target program, the method comprising:
detecting by a sensor whether an operator of the information processing apparatus is absent or not;
acquiring log information including information about a date and time that whether the operator is absent or not is detected by the sensor module and information about whether the operator is absent or not by a log information acquiring module;
analyzing an absence time zone in which the operator is absent based on the log information acquired by the log information acquiring module to set to execute the at least one executing target program in the absence time zone based on a result of the analysis by a scheduling module; and
executing the at least one executing target program in the absence time zone by a processor.

6. The method of claim 5, wherein
when the sensor module detects that the operator is present while the at least one executing target program is executed by the processor, the processor interrupts or stops execution of the at least one executing target program.

7. The method of claim 6, wherein
after the processor interrupts or stops execution of the at least one executing target program, the scheduling module analyzes a further absence time zone of the operator based on the log information acquired by the log information acquiring module to set to execute the at least one executing target program in the further absence time zone based on a result of the analysis.

8. The method of claim 6, wherein
after the processor interrupts execution of the at least one executing target program, the scheduling module analyzes a further absence time zone of the operator based on the log information acquired by the log information acquiring module to set to execute the at least one executing target program in the further absence time zone on a point where execution of the at least one executing target program is interrupted based on a result of the analysis.
